(19) United States
(12) Patent Application Publication
(10) Pub. No.: US 2025/0339807 A1
(43) Pub. Date: Nov. 6, 2025

(54) DIRECT AIR CAPTURE IN LIQUID-COOLED DATA CENTER ARCHITECTURE WITH DRY COOLER

(71) Applicant: Microsoft Technology Licensing, LLC, Redmond, WA (US)

(72) Inventors: Kathryn OSEEN-SENDA, Seattle, WA (US); Stephan Wayne GILGES, Seattle, WA (US); Eric Clarence PETERSON, Woodenville, WA (US); Husam ALISSA, Snoqualmie, WA (US); Bharath RAMAKRISHNAN, Kirkland, WA (US)

(73) Assignee: Microsoft Technology Licensing, LLC, Redmond, WA (US)

(21) Appl. No.: 18/652,092

(22) Filed: May 1, 2024

(51) Int. Cl. B01D 53/04; B01D 53/26

(52) U.S. Cl. CPC B01D 53/0438; B01D 53/0446; B01D 53/0454; B01D 53/265; B01D 2253/102; B01D 2257/504; B01D 2257/80; B01D 2258/06; B01D 2259/4009

(57) ABSTRACT

A direct air capture (DAC) system configured to remove carbon dioxide directly from ambient air uses a stack of enclosures each containing DAC media such as activated carbon. The DAC media enclosures have doors that open to allow airflow through the enclosure in an adsorption cycle and close to seal the enclosures to enable captured carbon dioxide to be pumped from the enclosures in a desorption cycle. The DAC system interoperates with a dry cooler that is operatively coupled to a liquid-cooling system for cooling equipment in a data center. Dry cooler fans are configured for extra duty by flowing ambient air through the DAC media enclosures while also flowing air across dry cooler heat exchangers. The DAC system taps hot working fluid from the dry cooler to provide heat to the DAC media enclosures to facilitate the desorption cycle to release captured carbon dioxide into the sealed enclosures.

### BACKGROUND

Many computer processors produce waste heat during operation. If the temperature of a processor increases above a certain threshold, performance of the processor may degrade, and, in some situations, the heat may damage the processor. Cooling systems are implemented in computing devices to reduce the processor temperature. A data center is a location that includes many servers filled with heat-generating processors. A data center cooling system may include a working fluid that absorbs the processor heat. This heat is often dispersed into the atmosphere or other heat sink.

Carbon dioxide is a product of many chemical reactions, including the combustion of fossil fuels. Atmospheric carbon dioxide contributes to the greenhouse effect in the atmosphere. Carbon capture and storage systems collect and store carbon dioxide from the atmosphere or other sources. Such systems may include chemical absorption, chemical adsorption, density separators, any other separators, and combinations thereof. Many carbon capture and storage systems utilize one or more heat sources and/or existing large airflow systems to collect, store, or release the carbon dioxide in a controlled setting.

### SUMMARY

A direct air capture (DAC) system is arranged for installation adjacent to a dry cooler used to cool heat-producing equipment such as computer servers in a data center. The DAC system interoperates with the dry cooler by sharing air handling from the dry cooler's fan system to facilitate carbon dioxide capture directly from the ambient air and by tapping into a working fluid loop in the dry cooler to provide heat used to release the captured carbon dioxide for collection and storage. The DAC system uses multiple enclosures each containing DAC media. The enclosures are controllably opened and closed to airflow for cyclical carbon dioxide adsorption and desorption processes.

During an adsorption cycle, air entry and exit doors to the enclosures are opened to permit airflow generated by the dry cooler fan system to contact the DAC media. Features located inside the DAC media enclosures are optionally provided and utilized to induce turbulence into the airflow in some implementations of the DAC system. The turbulence helps maximize the contact between the air and the DAC media to increase efficiency and capacity of the DAC system to capture carbon dioxide from the air.

During a desorption cycle, the entry and exit doors to the enclosures are closed to seal the enclosure. In an illustrative embodiment, hot working fluid from the dry cooler is distributed through a fluid distribution system disposed in a support structure of the DAC system. Supports for the DAC media enclosures include fluid carrying microchannels that provide heat to the DAC media to raise the media temperature to a point where the captured carbon dioxide is released from the media into the sealed enclosures. The carbon dioxide is pumped out of the sealed enclosures, compressed, and placed into storage.

Water vapor is pumped out of the sealed enclosures as a byproduct of desorption in DAC system embodiments in which the DAC media are water absorbing. Water is condensed from the evacuated vapor and provided to a water sprayer system that is utilized by the dry cooler when operated in a hybrid adiabatic mode to provide additional cooling of the working fluid.

The present DAC system advantageously utilizes the waste heat produced in a data center for carbon capture and footprint reduction while being easily and synergistically integrated into existing and new data center installations with a minimum amount of modifications to dry cooler infrastructure. The DAC media enclosures are designed to facilitate a modular architecture for the DAC system to make it easy to install, remove, and replace DAC media to meet applicable service and maintenance requirements for the system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 is a pictorial illustration of an exemplary use environment for a direct air capture (DAC) system that is arranged in accordance with the present principles;

FIG. 2 shows an illustrative liquid-cooling system used in a data center that interoperates with a dry cooler;

FIG. 3 provides a view of internal details of an illustrative dry cooler during operation;

FIG. 4 shows an illustrative water sprayer system used in a hybrid adiabatic dry cooler;

FIG. 5 shows illustrative arrangements of DAC systems that interoperate with a dry cooler;

FIG. 6 shows an illustrative DAC system that is coupled to a liquid-cooling system via connections with a dry cooler;

FIG. 7 shows an illustrative working fluid circulation system that is integrated with support structures utilized in a DAC system;

FIG. 8 shows an illustrative DAC media enclosure;

FIG. 9 shows an illustrative tiered array of DAC media enclosures as mounted in a support structure of a DAC system;

FIG. 10 shows airflow through a DAC system and dry cooler as configured for a carbon dioxide (CO₂) adsorption cycle;

FIG. 11 shows an illustrative array of DAC media enclosures as configured for a carbon dioxide desorption cycle;

FIG. 12 shows an illustrative arrangement for automated process monitoring and control for carbon dioxide capture;

FIG. 13 shows an illustrative method for operating a DAC system; and

FIG. 14 is a simplified block diagram of an illustrative computing device that may be used, at least in part, to implement aspects of the present principles.

Like reference numerals indicate like elements in the drawings. Elements are not drawn to scale in the drawings.

### DETAILED DESCRIPTION

Climate change caused by human emissions of greenhouse gases may pose an existential threat to many types of life and ecosystems on this planet. In addition to reducing new emissions, carbon capture of carbon dioxide (CO₂) already in the atmosphere is needed to avoid the worst impacts of climate change. The amount of carbon dioxide in the atmosphere in 2023 was around 420-424 parts per million (ppm). Removing carbon dioxide from the atmosphere can be used to bring the levels of climate warming gases down to safer levels and to gain time to decarbonize harder to abate industries.

Direct air capture (DAC) is a process of capturing carbon dioxide directly from ambient air and generating a concentrated stream of carbon dioxide for sequestration. The inventors of the present principles described herein have recognized that data centers have a perfect synergy of waste heat and existing air handling that promises the potential to greatly reduce DAC costs at scale.

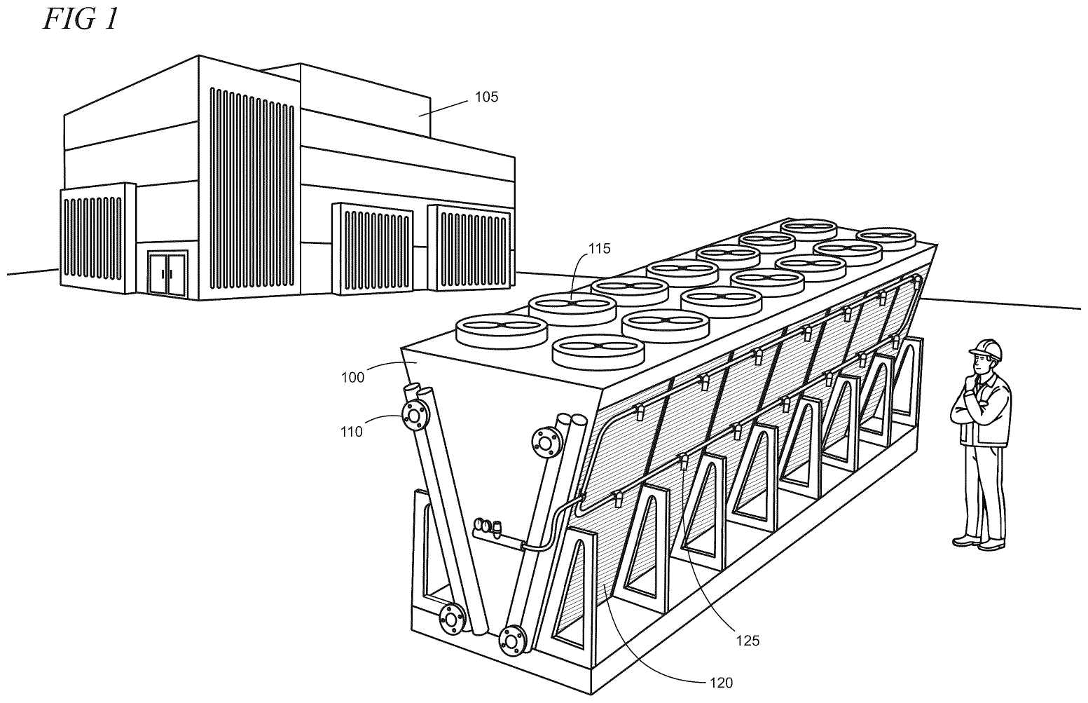

Turning now to the drawings, FIG. 1 is a pictorial illustration of an exemplary use environment for a DAC system that is arranged in accordance with the present principles. It is noted that the drawings are shown to illustrate features of the DAC system, its principles of operation, and interoperability with liquid-cooling systems and dry coolers. The drawings are schematic diagrams that include simplified graphical representations of major elements and components to convey information in an accessible way. The elements are not drawn to any scale and the relative sizes of the elements do not necessarily represent their true proportions.

As shown in FIG. 1, a dry cooler 100 is being installed as cooling infrastructure of a computing data center 105 to manage heat produced by heat-generating information technology (IT) equipment in the data center such as computer servers, storage systems, security and monitoring systems, and the like. The dry cooler is a commonly used cooling component that interoperates with a liquid-cooling system employed in the data center. The dry cooler 100 shown in the drawings and described in the accompanying text is utilized to illustrate various principles and features of the present invention. However, it is emphasized that the form factor of the dry cooler 100 is illustrative and is not limited to the V-shaped arrangement of heat exchangers with horizontally-mounted fans. Other dry cooler form factors, including horizontal and/or vertical arrangements of heat exchangers and fans, may also be utilized with the present DAC system.

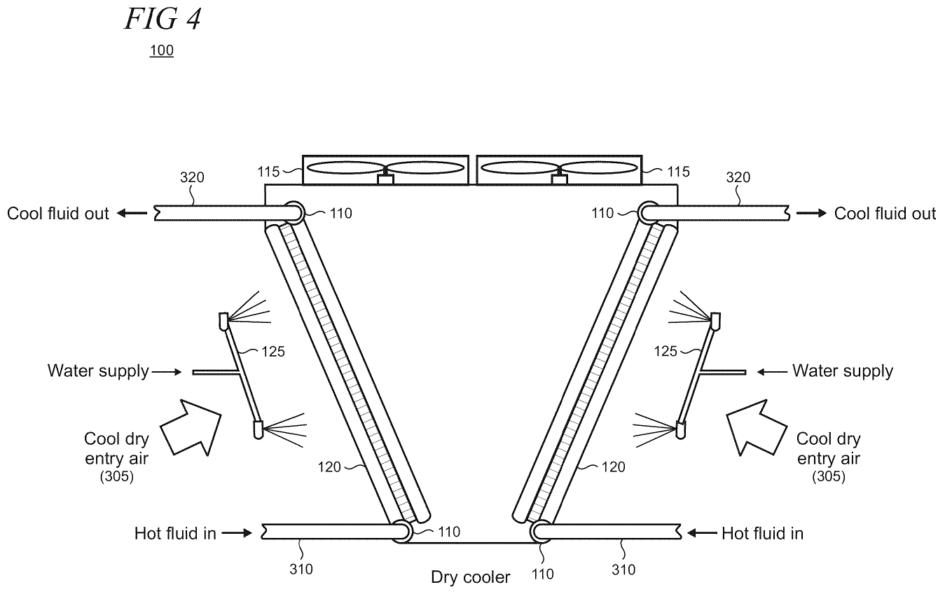

Dry coolers are generally installed on outside grounds of the data center to facilitate direct access to the ambient environment and are attached via couplers 110 to pipes and other fluid handling infrastructure (e.g., valves) to the data center liquid-cooling system. Electrically-operated fans 115 at the top of the dry cooler draw air from the surrounding environment through heat exchangers 120 on either side of the dry cooler 100. As shown in FIG. 1, the dry cooler is configured as a hybrid dry cooler by having a water sprayer system 125 (further details of the water sprayer system are discussed below in the text accompanying FIG. 4).

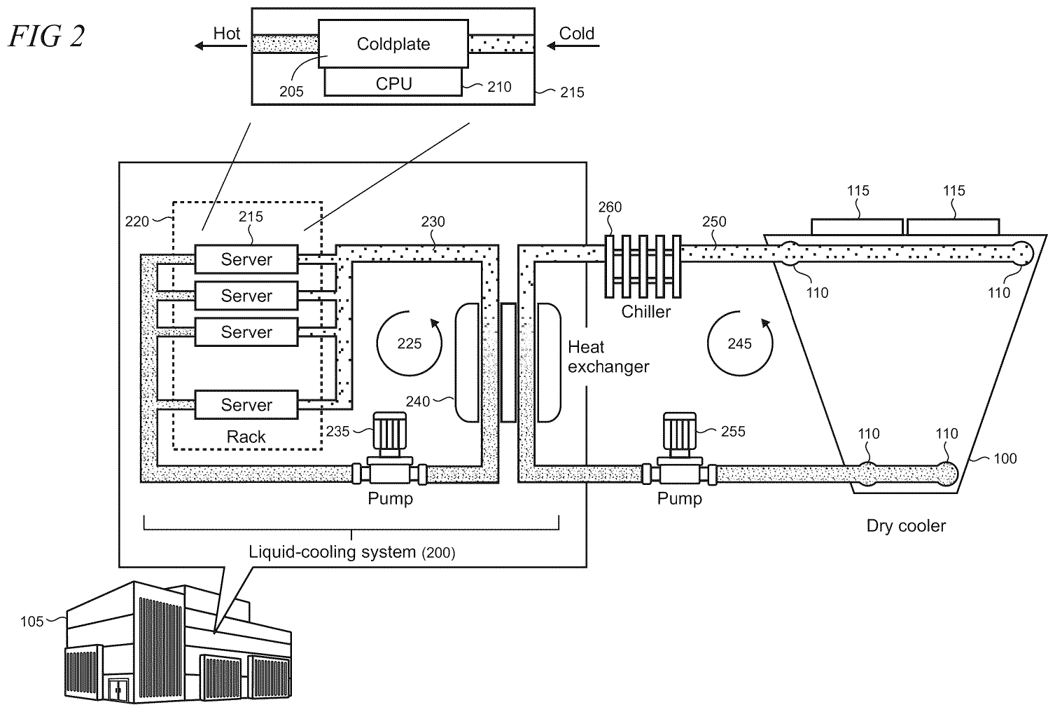

FIG. 2 is a simplified schematic diagram of a liquid-cooling system 200 utilized in the datacenter 105 to cool IT equipment in server rooms or other suitable locations. While liquid-cooling systems can vary by implementation, generally a heat-exchanging device such as a coldplate 205 is provided with intimate thermal contact with heat producing elements such as a central processing unit (CPU) 210 in a computing server 215. Multiple servers are typically installed in an IT equipment rack 220 and the server room generally supports multiple racks arranged in bays. Liquid-cooling systems can be implemented with varying levels of granularity, depending on applicable requirements, at the rack, bay, or room level, for example.

The coldplate 205 is plumbed into the liquid-cooling system 200 to collect the waste heat generated at the servers 215 in a first closed loop 225 of circulating working fluid 230 that is circulated by a pump 235 or other suitable fluid-moving device to a heat exchanger 240. The heat exchanger interoperates with the dry cooler 100 to transfer the heat to a second closed loop 245 of working fluid 250 that is circulated by a pump 255. A chiller 260 may be utilized in some implementations to provide additional cooling to the second closed loop of working fluid.

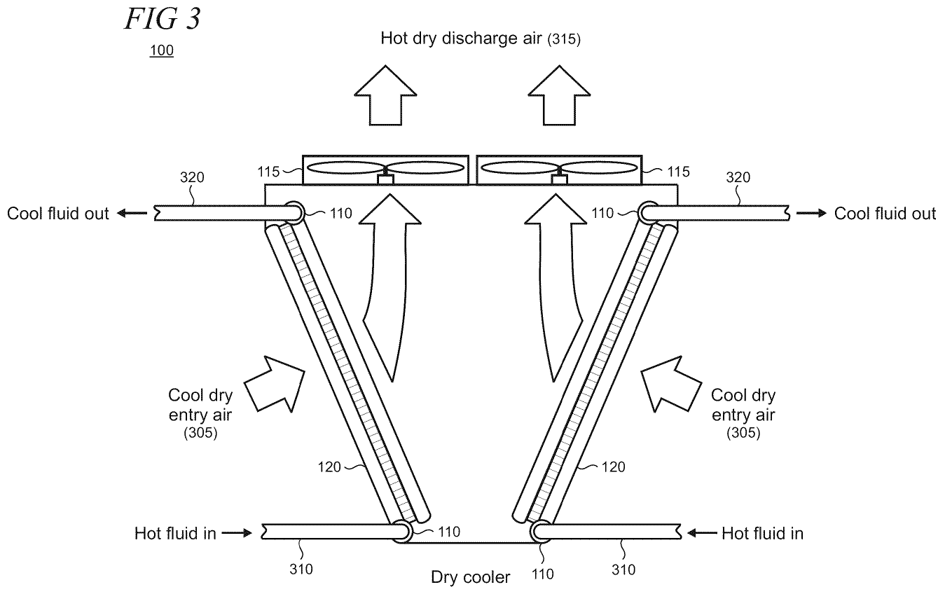

FIG. 3 provides a view of internal details of the dry cooler 100 during operation. Cool dry entry air 305 is drawn through the heat exchangers 120 by the rotating fans 115. Intake pipes 310 to the dry cooler carry hot working fluid from waste heat generated by the IT equipment in the data center 105 that is transferred to the air flowing past the heat exchangers. Hot dry discharge air (315) exits the dry cooler at the top. Return pipes 320 carry cool working fluid back to the heat exchanger 240 (FIG. 2) in the data center liquid-cooling system 200. It is noted that the intake pipes are shown at the bottom of the dry cooler and the return pipes at the top in this illustrative example. However, a reversed configuration with the hot working fluid entering at the top of the dry cooler and cool fluid exiting at the bottom may be used as an alternative.

In some implementations, as illustratively shown in FIG. 4, the dry cooler 100 is arranged as a hybrid dry cooler by being able to be operated in an adiabatic mode as a second mode of operation. The dry cooler is arranged for nominal operations in dry mode using the fans 115 to move the entry air past the heat exchangers 120. However, under some conditions (e.g., high ambient temperatures), the dry cooler can be switched to an adiabatic mode in which a mist of water from a sprayer system 125 is used to pre-cool the entry air 305 before it passes over the heat exchangers. In some implementations, an adiabatic pad (not shown) or other structure is utilized to retain water at its surface to enable entry-air pre-cooling while minimizing the wetting of the heat exchanger to protect against corrosion and scale.

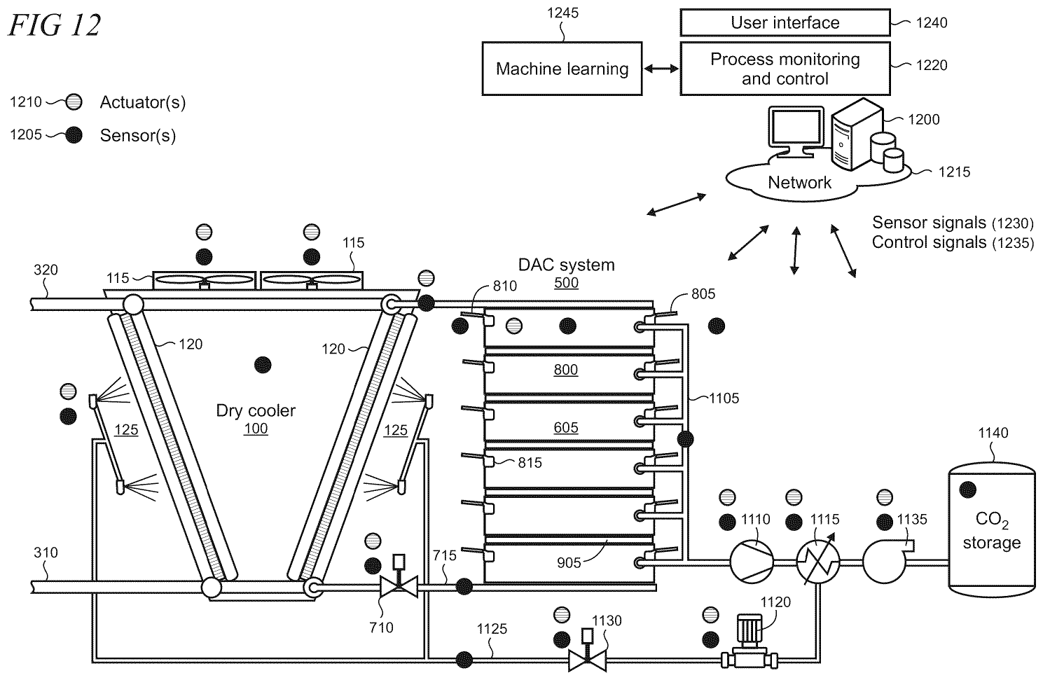

Adiabatic cooling can significantly increase the cooling capacity compared to dry mode alone and may be utilized to provide lower working fluid temperatures while using much less water than, for example, traditional evaporative cooling solutions. The hybrid dry cooler can be automatically switched between dry and adiabatic modes by a process monitoring and control system based on a variety of factors such as ambient conditions and cooling load, and optimization of water and energy usage, as discussed below in the text accompanying FIG. 12.

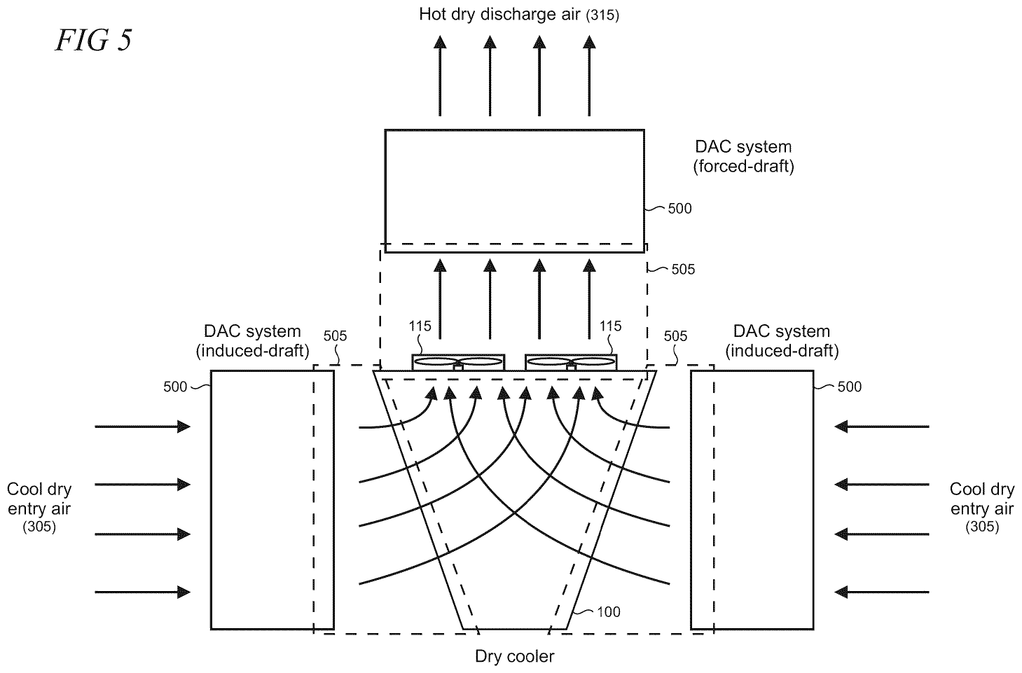

The present direct air capture (DAC) system is designed to interoperate with current dry cooler designs (both hybrid and non-hybrid) in both existing and new installations with only a minimal amount of adaptation and modification. FIG. 5 shows arrangements of an illustrative DAC system 500 that interoperates with the dry cooler 100. As shown, a DAC system may be located on either side of the dry cooler at the entry air side (i.e., upstream from the fans 115) in an induced-draft arrangement. Alternatively, a DAC system can be located at the exit of the fans (i.e., downstream from the fans) in a forced-draft arrangement. Suitable air ducting 505 between the DAC systems and dry cooler can be utilized to maximize airflow and fan efficiency.

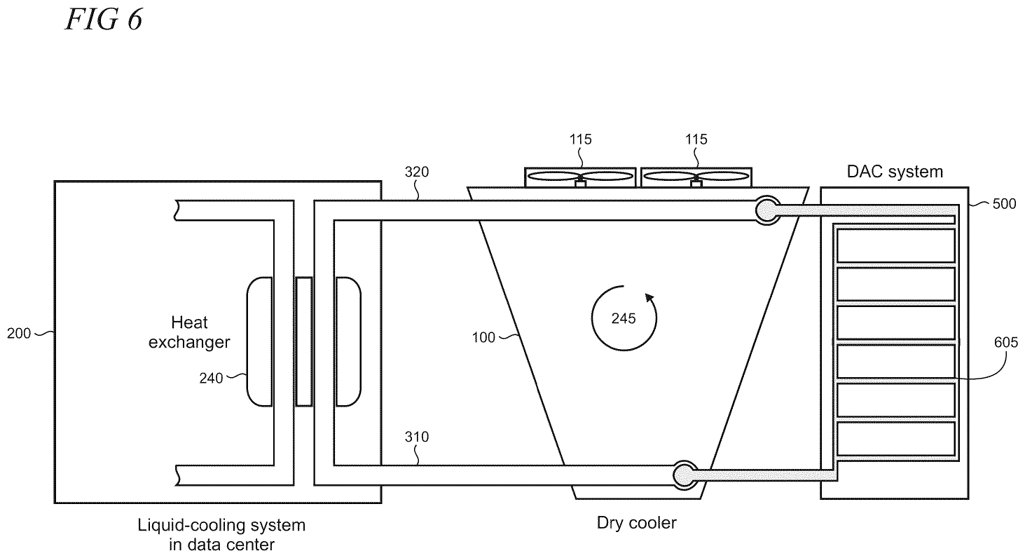

The DAC system 500 is coupled to the working fluid intake 310 and return 320 piping of the dry cooler 100, as shown in FIG. 6. As noted above, the dry cooler is coupled via the heat exchanger 240 to the liquid-cooling system 200 (FIG. 2) of the data center. The coupling effectively extends the second closed loop 245 to include a fluid distribution system 605 in the DAC system. In alternative implementations, the DAC system is coupled directly to the liquid-cooling system without the dry cooler being utilized as an intermediate component.

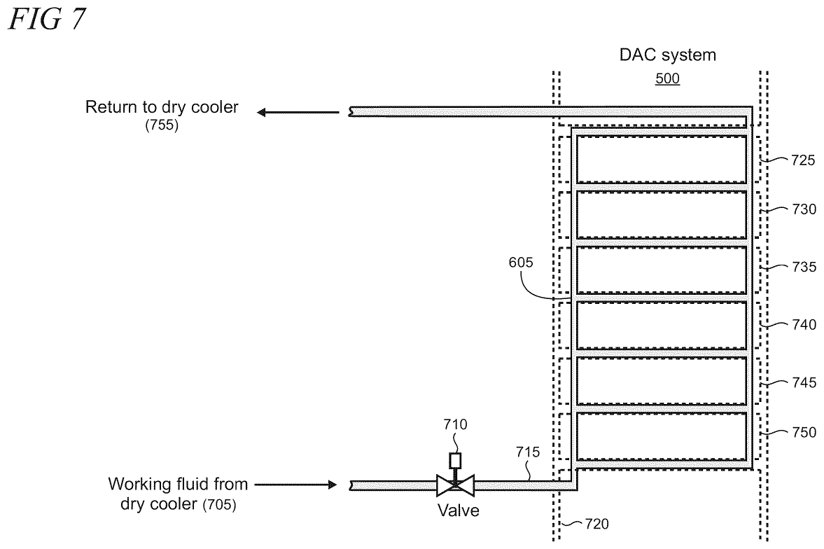

The extension of the second closed loop 245 provides for hot working fluid 705 from the dry cooler to be controllably circulated through the DAC system 500 through operation of a valve 710, as shown in FIG. 7. The circulation path 715 for the working fluid extends through the distribution system 605 that is integrated with a support structure 720 of the DAC system. The support structure provides spaces for multiple DAC media enclosures that are arranged in tiers. In this particular example six tiers, 725, 730, 735, 740, 745, and 750 are provided. However, this number of tiers is merely illustrative, and a tier arrangement utilized in any specific implementation can include more or fewer tiers as needed to meet applicable requirements. The working fluid passes through the distribution system on the top and bottom of each tier and is returned to the dry cooler 100 (FIG. 2) as indicated by reference numeral 755.

In other implementations of the DAC system, alternative sources to the dry cooler are utilized to provide hot fluid to the distribution system 605. Generally, the present DAC system can leverage waste heat sources and be readily integrated with a variety of energy systems. For example, waste heat from various industrial processes that are part of or separate from data center operations may be captured and utilized to provide a heat source for DAC media desorption. Renewable energy sources (e.g., solar thermal energy) and sources of stored thermal energy may also be utilized alone or in combination with other heat sources. Low-grade heat sources can be supplemented using heat from heat pumps and the like. In alternative embodiments, heat and working fluid systems utilized for desorption processes can be provided on a standalone basis without being integrated into other energy sources or systems.

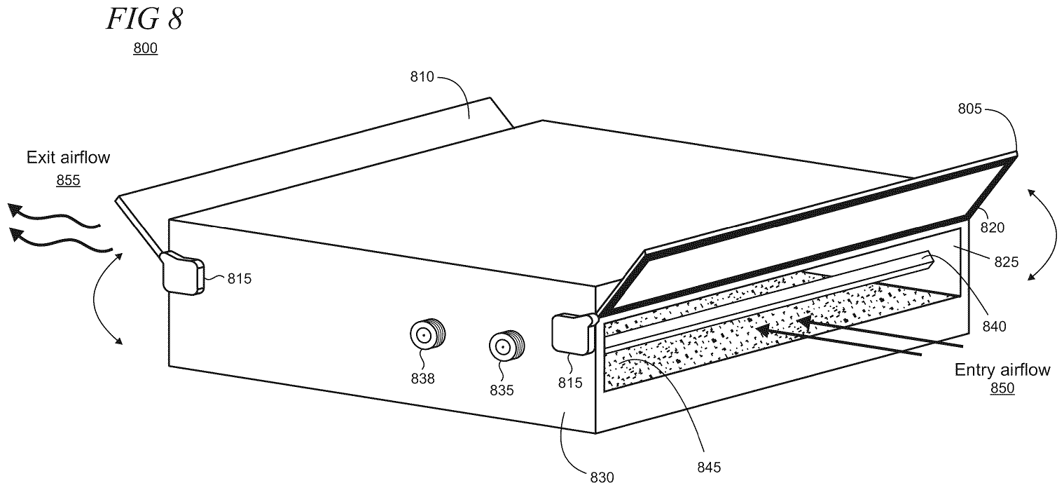

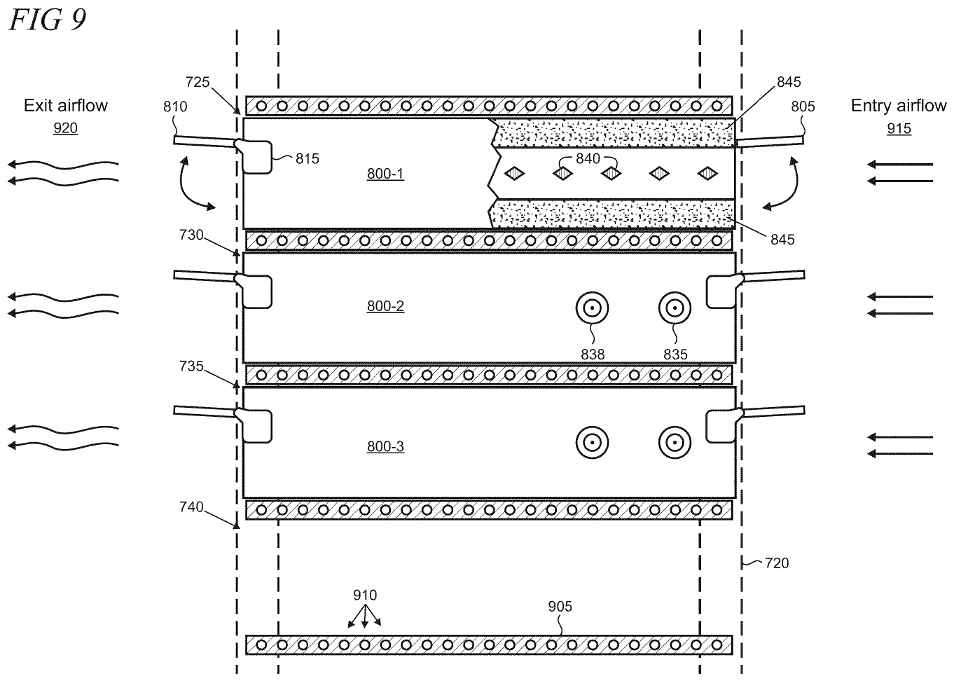

FIG. 8 is a pictorial representation of an illustrative DAC media enclosure 800 arranged in accordance with the present principles. DAC media enclosures may be deployed in the present DAC system in a tiered configuration, as shown in FIG. 9. The DAC media enclosure 800 is configured to be airtight when front and rear doors 805 and 810 are closed and flow air when the doors are opened. The doors are operated by actuators 815 that can operate, for example, electrically, hydraulically, or pneumatically. In alternative implementations, the doors are operable manually. The doors are rotatably hinged in this illustrative example, but other types of access devices (e.g., cover, flaps, panels, etc.) and operating mechanisms (e.g., sliding, bi-fold, etc.) may be utilized to effectuate a flow-through container that can be alternatively opened and sealed. In some applications, the doors can be configured to be partially opened or closed to regulate airflow through the enclosure.

A gasket 820, or other suitable elastically-deformable seal, is located on the doors and/or around the periphery of the opening 825 can be utilized to enhance the sealing quality of the doors to the enclosure body 830 in some applications. Latches or equivalent structures can also be utilized in some applications to provide positive door closure and sealing. Note, however, that the negative pressure (i.e., less than atmospheric pressure) inside the enclosure will tend to pull the doors in towards the interior of the enclosure during a desorption cycle when captured carbon dioxide is pumped out. This inward force will tend to compress the gasket which may enhance the quality of the seal and limit air intrusion.

An evacuation port 835 is provided on the body 830 of the DAC media enclosure 800. The evacuation port is adapted to mate with a suitable connector on a hose or pipe (not shown) to enable captured carbon dioxide to be pumped out of the DAC media enclosure 800 and stored, as discussed below. The location and number of evacuation ports utilized can vary by implementation. An injection port 838 is optionally provided on the enclosure body. The injection port is adapted to mate with a suitable connector on a hose or pipe (not shown) to displace oxygen (and other weakly adsorbed gases in some cases) prior to the desorption cycle. It may be appreciated that high oxygen concentrations can pose safety risks and interfere with downstream processing steps. Providing the injection port ensures the desorbed carbon dioxide stream has a low oxygen content, making it suitable for further handling and storage.

Internal features 840 of the enclosure are optionally utilized in some embodiments of the present principles. When utilized, the internal features are configured to increase turbulence in the airflow through the enclosure to maximize the mixing of the flowing air with the DAC media 845 during carbon dioxide adsorption. It may be appreciated that use of the turbulence-inducing features can depend on flow geometry of the enclosure and adsorbent characteristics of the DAC media. A given DAC system design may benefit from utilization of the features while other designs may not. Typically, a design choice involves balancing the need for air mixing with the DAC media against the pressure drop across the enclosure.

Turbulent airflow can improve the efficiency and capacity of the DAC system to capture carbon dioxide from the air in some cases. Turbulent airflow may help maximize the contact between the air and the DAC media, allowing more carbon dioxide to be captured. The low concentration of carbon dioxide in ambient air (i.e., ˜0.042%) means efficient mixing and air contact with the DAC media is important for effective carbon capture. The location, shape, and number of internal turbulence-inducing features utilized can vary by implementation. As shown in the drawing, the entry airflow 850 is laminar while the exit airflow 855 is turbulent.

The DAC media 845 is located in a layer on each of the top and bottom internal surfaces of the enclosure in this illustrative example. The DAC media comprises a temperature-sensitive adsorbent material that captures carbon dioxide at a relatively low temperature (e.g., less than 35 degrees C.) while releasing carbon dioxide at a relatively high temperature (e.g., greater than 40 degrees C.). Adsorption is a reversible process where the solid adsorbent captures the molecules, atoms, or ions of gases and liquids on its surface by physical means such as van der Waals forces or by forming chemical bonding. The reversibility of the adsorption process is a function of temperature and pressure, which means the adsorption and desorption capability of the DAC media can vary by varying both temperature and pressure. In an alternative embodiment of the DAC system, temperature-insensitive DAC media are utilized. In this case, desorption is facilitated using other suitable methodologies including, for example and not by way of limitation, variable vapor pressure, electro-magnetic stimulation (e.g., through suitable application of voltage, current, magnetic field, etc.), or using a combination of techniques.

Common adsorbents include carbonaceous materials which possess a high adsorption capacity and long-term stability. Carbonaceous materials include activated carbon, coal-derived carbons, polymer-derived carbons, metal-organic frameworks-derived carbons, carbon nanotubes, graphene oxides, and carbon aerogels. Other adsorbents which may be suitable in some DAC applications include zeolites, amine-functionalized solid sorbents, metal oxides, metal organic frameworks (MOFs), covalent organic frameworks (COFs), porous silica and carbon, and silica aerogels.

FIG. 9 shows an illustrative tiered array of DAC media enclosures 800 (designated as 800-1, 800-2, and 800-3) as mounted in the support structure 720 of the DAC system 500 in the top three tiers 725, 730, and 735. The vertical elements of the support structure are shown in dashed line for sake of clarity in illustration. The fourth tier 740 is shown in the drawing as being unfilled to illustrate the modularity of the DAC system. The modularity feature enables replacement DAC media to be readily installed and uninstalled to facilitate service and maintenance of the DAC system. For example, in some embodiments, the DAC media enclosures are designed to be removably installed with a minimum of tools by sliding the enclosures into the receiving spaces in the support structure. Once located in the receiving space, electrical connections for the door actuators and vapor collection connections to the evacuation port can be made to complete the installation.

The horizontal supports on the top and bottom of each tier 725, 730, 735, and 740 are representatively indicated by reference numeral 905 in FIG. 9. Working fluid passages 910 are included in the horizontal supports and are aligned in a substantially perpendicular direction to the entry 915 and exit 920 airflow, as shown in the cross-sectional view. The fluid passages are configured to maximize heat transfer to the DAC media 845 during a desorption cycle, as discussed below. The fluid passages can be embodied as microchannels (e.g., diameter <1 mm) to provide a relatively high surface area-to-volume ratio to further enhance heat transfer from the fluid to the DAC media. In alternative embodiments of the present DAC system, the fluid channels may be supplemented or replaced entirely by a heat delivery configuration in which the DAC media is bathed directly by hot working fluid. For example, some or all of the DAC media can be partially or fully immersed within the hot working fluid to facilitate carbon desorption.

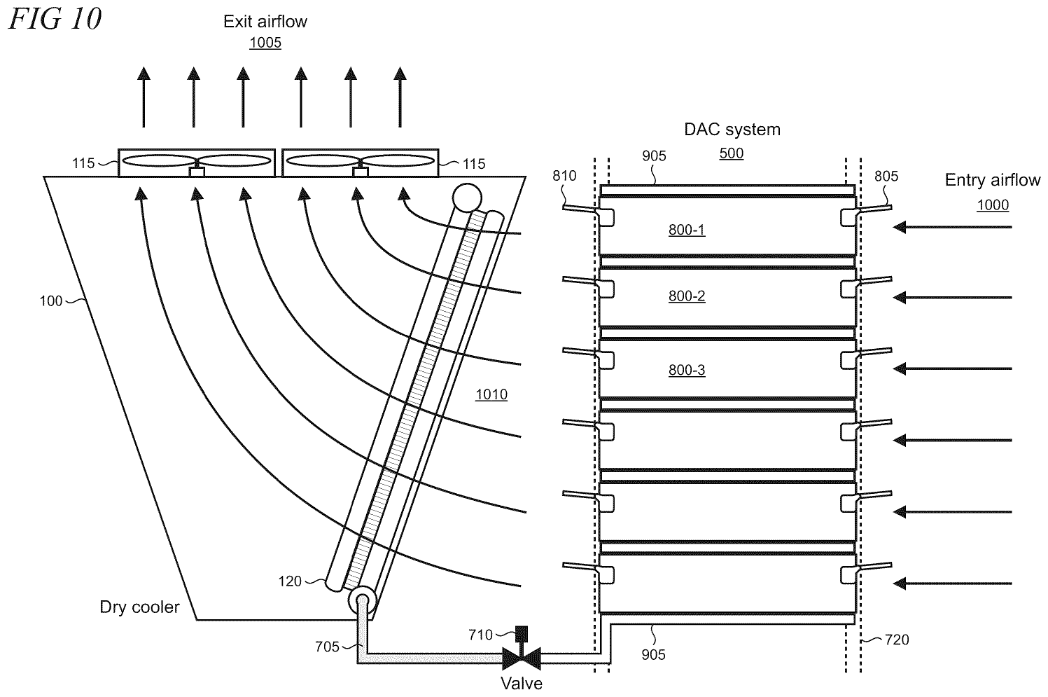

During an adsorption cycle to capture carbon dioxide, as shown in FIG. 10, the front 805 and rear 810 doors of each DAC media enclosure (e.g., 800-1, -2, etc.) are opened to enable airflow through each of the enclosures deployed in the DAC system 500 (the ducting is not shown for clarity). The valve 710 is shut to limit the working fluid 705 from the dry cooler from entering the fluid distribution system in the DAC system and flowing through the fluid passages in the horizontal supports. In alternative implementations, appropriate fluid plumbing and valve arrangements may be utilized (not shown) to enable cool working fluid to enter the fluid distribution system and passages during an adsorption cycle to ensure that the DAC media is within a target range of temperatures (e.g., less than 35 degrees C.). Alternating circulation of hot and cool working fluid from the dry cooler through the DAC system may facilitate more rapid cycling of adsorption and desorption in some applications.

Operation of the fans 115 in the dry cooler 100 creates negative pressure to pull entry air 1000 through the DAC system and past the heat exchanger 120 (i.e., induced-draft). The air exits at the top of the dry cooler, as indicated by reference numeral 1005. The entry airflow to the DAC system 500 includes a mixture of gasses including a concentration of carbon dioxide. As the air passes through the DAC media enclosures 800 and is turbulently impinged with the DAC media 845 (FIG. 8), the DAC media captures at least a portion of the concentration of carbon dioxide. The carbon dioxide-depleted air 1010 exits the DAC system and enters the dry cooler to provide cooling to the heat exchanger 120 in a conventional dry cooling process.

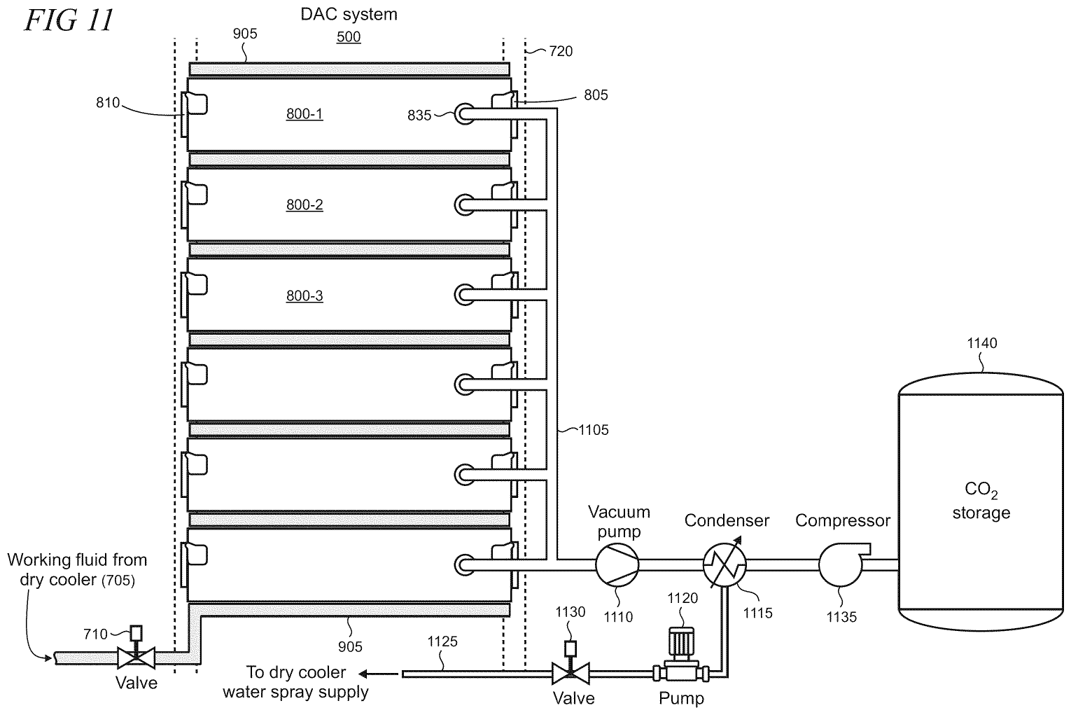

During a desorption cycle to release carbon dioxide from the DAC media 845 (FIG. 8), as shown in FIG. 11, the front 805 and rear 810 doors of each DAC media enclosure (e.g., 800-1, -2, etc.) are closed to effectuate an airtight seal for each of the enclosures deployed in the DAC system 500. The valve 710 is opened to allow hot working fluid to circulate through the fluid distribution system and the channels in each of the horizontal supports 905 to apply heat to the DAC media to bring the media up to a sufficient temperature to cause desorption. In some applications, supplemental heat devices, such as heat pumps, may be utilized to raise the temperature of the DAC media and/or the working fluid.

The released carbon dioxide is evacuated from the DAC media enclosures 800 through a collection system 1105 coupled to a vacuum pump 1110 or other suitable device that operates to remove the released carbon dioxide from the enclosures. With the provisioning of suitable DAC media and methods, other climate warming gasses such as methane can be captured and evacuated from the enclosures. Some types of solid sorbents in DAC media can release water as a byproduct of DAC processing, although not all types of DAC media suitable for the present DAC system need to be water absorbing. Thus, in some embodiments of the DAC system, the released carbon dioxide is mixed in a vapor that includes water. The water is removed at a condenser 1115. In some cases, the water can include contaminants that were present in the entry airflow. Filters, separators, and/or membranes (not shown) incorporated into the condenser or implemented as separate components may be utilized to separate the contaminants from the water vapor. The condensed water is pumped out of the DAC system by a pump 1120 to a water line 1125 controlled by a valve 1130. The water line is coupled to a supply for the water sprayer system 125 (FIGS. 1 and 4) for the dry cooler when operated as a hybrid adiabatic dry cooler.

A compressor 1135 compresses the carbon dioxide gas stream (minus water) for storage in a storage tank 1140. The carbon dioxide released during a desorption cycle may alternatively be stored in any other suitable fashion, including as gaseous, solid, liquid, mixed with other chemicals, and the like. For example, the released carbon dioxide may be processed into a form that enables sequestration in concrete construction materials. In this process, captured carbon dioxide reacts with residual cement in waste concrete forming calcium carbonate that is permanently stored within a new concrete mix. This enables the carbon dioxide to be durably sequestered and not released back into the atmosphere even if the concrete is later demolished.

The processes for cyclical carbon dioxide adsorption and desorption using the DAC system 500 arranged in accordance with the present principles may be automated using a suitable computing system 1200 and communication technologies, as shown in FIG. 12. The computing system is operatively coupled to a multiplicity of sensors (indicated by the solid dot 1205) and actuators (indicated by the hatched dot 1210) over a communications network 1215. The communications network may be implemented using any of a variety of network types, architectures, and topologies including, for example, local/enterprise and cloud-computing networks. The network supports wired and wireless communications technologies and protocols such as Internet of Things (IoT) systems.

The computing system 1200 is configured to support a process monitoring and control application 1220 that receives signals 1230 from the sensors 1205 over the network 1215. The sensors continuously monitor and measure critical process variables such as temperature, pressure, flow rate, level, concentration, and other parameters. Based on the received sensor signals, the application applies various programming and algorithms to automatically adjust process inputs to maintain desired process conditions. For cyclical processes such as carbon dioxide adsorption and desorption, the application manages an appropriate sequence of process steps and operation phases and coordinates equipment set up and scheduling with human operators as needed.

The process monitoring and control application 1220 sends control signals 1235 and other process commands to the actuators 1210 over the network. The application exposes a user interface 1240 to users to enable interactions with the application to monitor and control carbon dioxide adsorption and desorption processing. The user interface can raise alarms and alerts when monitored processing parameters fall outside certain user-defined limits. The application can include common process control features such as data and event logging and reporting and event escalation to various higher-level supervisory control systems that may be in use in the data center.

The sensors 1205 and actuators 1210 are selected from a variety of different types to support various functions. The sensors and actuators are typically distributed throughout the dry cooler 100 and DAC system 500 and may extend to the liquid-cooling system in the data center in some cases. Generally, any device used in the carbon dioxide adsorption and desorption processing having variable and controllable states is equipped with an actuator to control the device state and one or more sensors to monitor the device state.

For example, the valves 710 and 1130 may be equipped with sensors to monitor, for example, one or more of line temperature, pressure, flow rates, and the like, and have a controllable actuator configured, for example, to operate the valve between fully opened and fully closed positions in response to a control signal from the process monitoring and control application 1220. The fans may be equipped with sensors, for example, to monitor fan speed, motor temperature, etc., and may be configured with controllable actuators to control fan speed. The door actuators 815 may be controllable in response to control signals and be instrumented, for example, with suitable sensors to detect door position. The water sprayer system 125 may be configured with controllable sprayer heads and use sensors for monitoring one or more of, for example, water pressure, temperature, flow rate, and moisture content of an adiabatic pad when used.

Various airflow rate, pressure, humidity, and temperature sensors and the like may be distributed throughout the airflow paths in the DAC system 500 and dry cooler 100. The various fluid lines and loops in the DAC system and dry cooler are typically instrumented, for example, with suitable pressure, temperature, and flow rate sensors. The DAC media enclosures 800 and the collection system 1105 are likewise instrumented with sensors, for example, to monitor one or more of airflow, temperature, humidity, pressure, and the like. Pumps 1110 and 1120, condenser 1115, and compressor 1135 are configurable, for example, with controllable actuators and sensors for state-monitoring of parameters such as pressure and temperature. The carbon dioxide storage tank 1140 may support temperature and pressure sensing and include controllable valves and the like (not shown). Alarm and safety interlocks (not shown) are also typically included in the DAC system 500 and dry cooler 100 and monitored and controlled by the process monitoring and control application 1220.

A machine learning module 1245 is optionally utilized in some implementations of the present DAC system to implement process control strategies using predictive control techniques. The machine learning module is typically trained with a training dataset that includes patterns between the various operating parameters of the DAC system 500. Using the patterns identified by the machine learning module, process monitoring and control application 1220 adjusts one or more operating parameters to improve performance of the DAC system.

In some embodiments, the machine learning module 1245 receives input regarding various parameters from the sensors 1205. For example, the machine learning module may receive input regarding ambient air temperature, ambient air humidity, computing load of the data center, working fluid temperature, adsorption cycle time, desorption cycle time, pre-capture ambient air carbon dioxide concentration, post-capture ambient air carbon dioxide concentration, ambient air velocity, ambient air pressure drop, fan speed, number of fans operating, status of supplemental heaters, DAC media enclosure vacuum pressure, mass of carbon dioxide captured per cycle, mass of water captured per cycle, power use per component, any other parameter, and combinations thereof. Use of the machine learning module may help to reduce the cost of carbon dioxide capture using the present DAC system.

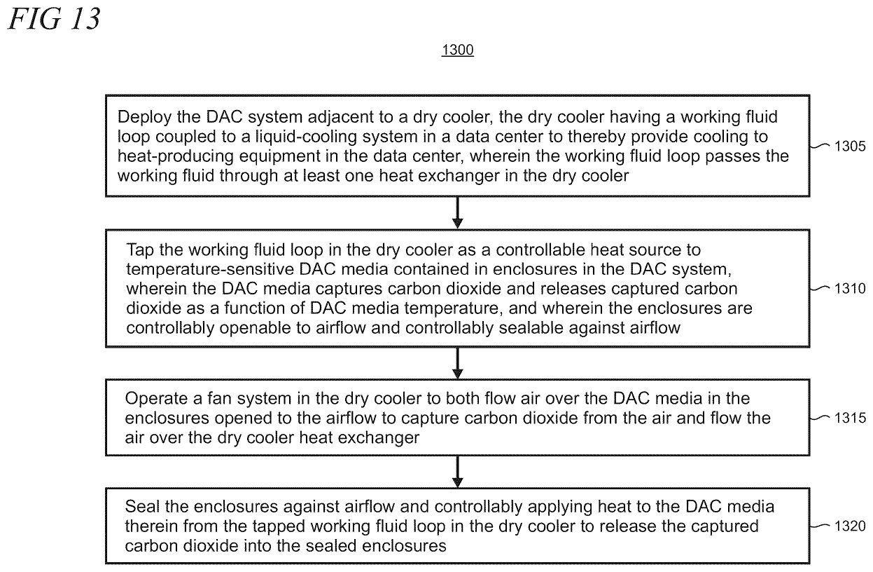

FIG. 13 a flowchart of an illustrative method 1300 for operating a DAC system configured to capture carbon dioxide from air in an environment surrounding the DAC system. Unless specifically stated, the methods or steps shown in the flowchart and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 1305 includes deploying the DAC system adjacent to a dry cooler, the dry cooler having a working fluid loop coupled to a liquid-cooling system in a data center to thereby provide cooling to heat-producing equipment in the data center, wherein the working fluid loop passes the working fluid through at least one heat exchanger in the dry cooler.

Block 1310 includes tapping the working fluid loop in the dry cooler as a controllable heat source to temperature-sensitive DAC media contained in enclosures in the DAC system, wherein the DAC media captures carbon dioxide and releases captured carbon dioxide as a function of DAC media temperature, and wherein the enclosures are controllably openable to airflow and controllably sealable against airflow.

Block 1315 includes operating a fan system in the dry cooler to both flow air over the DAC media in the enclosures opened to the airflow to capture carbon dioxide from the air and flow the air over the dry cooler heat exchanger. Block 1320 includes sealing the enclosures against airflow and controllably applying heat to the DAC media therein from the tapped working fluid loop in the dry cooler to release the captured carbon dioxide into the sealed enclosures.

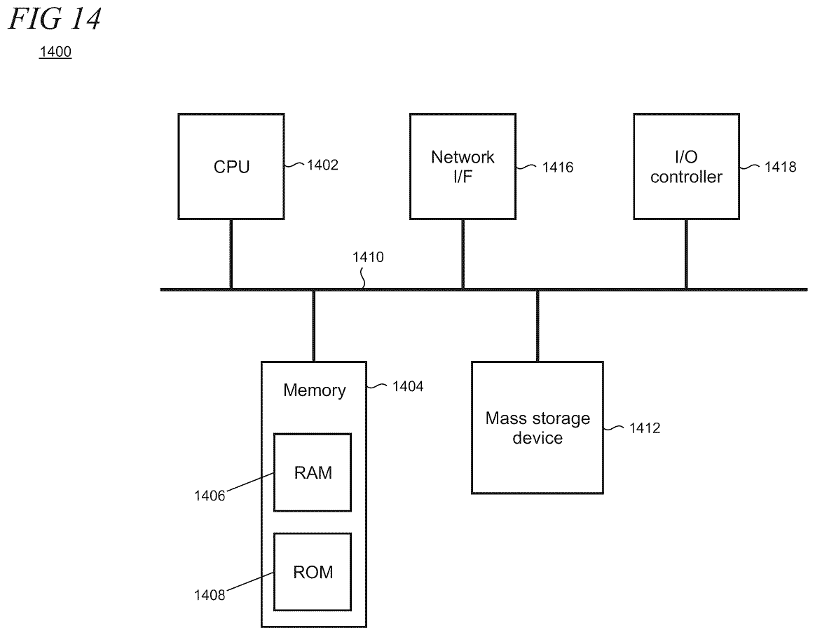

FIG. 14 shows an illustrative architecture 1400 for a computing device, such as a server, capable of executing the various components described herein. The architecture 1400 illustrated in FIG. 14 includes one or more processors 1402 (e.g., central processing unit, dedicated AI (artificial intelligence) chip, graphics processing unit, etc.), a system memory 1404, including RAM (random access memory) 1406 and ROM (read only memory) 1408, and a system bus 1410 that operatively and functionally couples the components in the architecture 1400. A basic input/output system containing the basic routines that help to transfer information between elements within the architecture 1400, such as during startup, is typically stored in the ROM 1408. The architecture 1400 further includes a mass storage device 1412 for storing software code or other computer-executed code that is utilized to implement applications, a file system, and an operating system (OS). The mass storage device 1412 is connected to the processor 1402 through a mass storage controller (not shown) connected to the bus 1410. The mass storage device 1412 and its associated computer-readable storage media provide non-volatile storage for the architecture 1400. Although the description of computer-readable storage media contained herein refers to a mass storage device, such as an HDD (hard disk drive) or CD (compact disc) drive, it may be appreciated by those skilled in the art that computer-readable storage media can be any available storage media that can be accessed by the architecture 1400.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray or other optical storage, magnetic cassettes, magnetic tape, magnetic disk storage or other magnetic storage devices, or any other medium which can be used to store the desired information and which can be accessed by the architecture 1400.

According to various embodiments, the architecture 1400 may operate in a networked environment using logical connections to remote computers through a network. The architecture 1400 may connect to the network through a network interface unit 1416 connected to the bus 1410. It may be appreciated that the network interface unit 1416 also may be utilized to connect to other types of networks and remote computer systems. The architecture 1400 also may include an input/output controller 1418 for receiving and processing input from a number of other devices, including a keyboard, mouse, touchpad, touchscreen, and control devices such as buttons and switches or electronic stylus (not shown in FIG. 14). Similarly, the input/output controller 1418 may provide output to a display screen, user interface, a printer, or other type of output device (also not shown in FIG. 14).

It may be appreciated that the software components described herein may, when loaded into the processor 1402 and executed, transform the processor 1402 and the overall architecture 1400 from a general-purpose computing system into a special-purpose computing system customized to facilitate the functionality presented herein. The processor 1402 may be constructed from any number of transistors or other discrete circuit elements, which may individually or collectively assume any number of states. More specifically, the processor 1402 may operate as a finite-state machine, in response to executable instructions contained within the software modules disclosed herein. These computer-executable instructions may transform the processor 1402 by specifying how the processor 1402 transitions between states, thereby transforming the transistors or other discrete hardware elements constituting the processor 1402.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1400 in order to store and execute the software components presented herein. It also may be appreciated that the architecture 1400 may include other types of computing devices, including wearable devices, handheld computers, embedded computer systems, smartphones, PDAs (personal digital assistants), and other types of computing devices known to those skilled in the art. It is also contemplated that the architecture 1400 may not include all of the components shown in FIG. 14, may include other components that are not explicitly shown in FIG. 14, or may utilize an architecture completely different from that shown in FIG. 14.

Various exemplary embodiments of the present Direct Air Capture in Liquid-Cooled Data Center Architecture with Dry Cooler are now presented by way of illustration and not as an exhaustive list of all embodiments. An example includes a direct air capture (DAC) media enclosure, comprising: an enclosure body having openings configured for air to flow through the body, the openings including an airflow entry to the body and an airflow exit from the body; an entry door at the airflow entry of the body having an open position and a closed position; an exit door at the airflow exit of the body having an open position and a closed position, wherein the open positions for entry door and exit door allow air to flow through the body and wherein the closed positions for the entry door and exit door provide for the enclosure body to be sealed against airflow; and DAC media located within the body for alternately adsorbing carbon dioxide from ambient air flowing through the DAC media enclosure and desorbing carbon dioxide into the DAC media enclosure, wherein the adsorption and desorption are dependent on a temperature of the DAC media.

In another example, the DAC media comprises a temperature-sensitive solid carbon-based sorbent. In another example, the DAC media comprises a non-carbon-based sorbent selected from one of zeolites, amine-functionalized solid sorbents, metal oxides, metal organic frameworks (MOFs), covalent organic frameworks (COFs), porous silica and carbon materials, or silica aerogels. In another example, the DAC media enclosure further includes turbulence-inducing features located within the body to cause airflow within the DAC media enclosure to have increased turbulence to maximize contact between the ambient air and the DAC media. In another example, the DAC media enclosure further includes one or more actuators for moving the entry door or exit door between open and closed positions. In another example, the DAC media enclosure further includes an evacuation port disposed on the body, the evacuation port configured for coupling to a pump for pumping out vapor including desorbed carbon dioxide from the DAC media enclosure when the entry and exit doors are closed to thereby seal the enclosure body. In another example, the DAC media enclosure further includes a gasket disposed on at least one of the entry door or exit door, the gasket facilitating an airtight seal for the entry door or exit door when in the closed position.

A further example includes a direct air capture (DAC) system for removing carbon dioxide from ambient air, the DAC system configured for installation with a dry cooler having a fan for fan-driven air draft over a heat exchanger in the dry cooler, comprising: one or more enclosures containing temperature-sensitive DAC media, wherein the enclosures are selectively opened to the ambient air or closed to the ambient air; a support structure providing a plurality of spaces for receiving the enclosures, wherein upon DAC system installation, the support structure exposes the enclosures and enclosed DAC media to an air draft generated by the fan; a coupling to the dry cooler to tap into a closed loop of working fluid in the dry cooler, the closed loop of working fluid providing cooling by the heat exchanger of heat-producing equipment; and a fluid distribution system disposed in the support structure for distributing working fluid from the dry cooler to the plurality of receiving spaces in the support structure to provide a source of heat to the DAC media in the enclosures received in the support structure.

In another example, the DAC system and dry cooler are positioned relative to each other to implement an induced-draft arrangement for the DAC system. In another example, the DAC system and dry cooler are positioned relative to each other to implement a forced-draft arrangement for the DAC system. In another example, the heat applied to the DAC media raises a temperature of the DAC media to a level sufficient to cause desorption of carbon dioxide captured from ambient air in the DAC media. In another example, the DAC system further comprises a plurality of microchannels in the support structure providing the receiving spaces, the microchannels providing working fluid channels for the fluid distribution system. In another example, the enclosures and support structure are adapted to enable the enclosures to be removably inserted in the support structure. In another example, the enclosures are selectively opened or closed using one of movable door, cover, flap, or panel. In another example, the heat-producing equipment comprises computer equipment located in a data center, the data center having a liquid-cooling system for the computer equipment, and wherein the closed loop of working fluid is adapted to exchange heat with the liquid-cooling system.

A further example includes a method of operating a direct air capture (DAC) system configured to capture carbon dioxide from air in an environment surrounding the DAC system, the method comprising: deploying the DAC system adjacent to a dry cooler, the dry cooler having a working fluid loop coupled to a liquid-cooling system in a data center to thereby provide cooling to heat-producing equipment in the data center, wherein the working fluid loop passes the working fluid through at least one heat exchanger in the dry cooler; tapping the working fluid loop in the dry cooler as a controllable heat source to temperature-sensitive DAC media contained in enclosures in the DAC system, wherein the DAC media captures carbon dioxide and releases captured carbon dioxide as a function of DAC media temperature, and wherein the enclosures are controllably openable to airflow and controllably sealable against airflow; operating a fan system in the dry cooler to both flow air over the DAC media in the enclosures opened to the airflow to capture carbon dioxide from the air and flow the air over the dry cooler heat exchanger; and sealing the enclosures against airflow and controllably applying heat to the DAC media therein from the tapped working fluid loop in the dry cooler to release the captured carbon dioxide into the sealed enclosures.

In another example, the method further includes evacuating the carbon dioxide from the sealed enclosures using a pump in the DAC system. In another example, the method further includes using a compressor in the DAC system to compress the evacuated carbon dioxide for storage. In another example, the method further includes evacuating water vapor from the sealed enclosures, condensing water from the evacuated vapor, and providing the condensed water to a water supply for a water sprayer system utilized by the dry cooler in an adiabatic cooling process. In another example, the method is automated using a computer-implemented process monitoring and control application that implements predictive control techniques based on machine learning.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A direct air capture (DAC) media enclosure, comprising:
an enclosure body having openings configured for air to flow through the body, the openings including an airflow entry to the body and an airflow exit from the body;
an entry door at the airflow entry of the body having an open position and a closed position;
an exit door at the airflow exit of the body having an open position and a closed position, wherein the open positions for entry door and exit door allow air to flow through the body and wherein the closed positions for the entry door and exit door provide for the enclosure body to be sealed against airflow; and
DAC media located within the body for alternately adsorbing carbon dioxide from ambient air flowing through the DAC media enclosure and desorbing carbon dioxide into the DAC media enclosure, wherein the adsorption and desorption are dependent on a temperature of the DAC media.

2. The DAC media enclosure of claim 1 in which the DAC media comprises a temperature-sensitive solid carbon-based sorbent.

3. The DAC media enclosure of claim 1 in which the DAC media comprises a non-carbon-based sorbent selected from one of zeolites, amine-functionalized solid sorbents, metal oxides, metal organic frameworks (MOFs), covalent organic frameworks (COFs), porous silica and carbon materials, or silica aerogels.

4. The DAC media enclosure of claim 1 further including turbulence-inducing features located within the body to cause airflow within the DAC media enclosure to have increased turbulence to maximize contact between the ambient air and the DAC media.

5. The DAC media enclosure of claim 1 further including one or more actuators for moving the entry door or exit door between open and closed positions.

6. The DAC media enclosure of claim 1 further including an evacuation port disposed on the body, the evacuation port configured for coupling to a pump for pumping out vapor including desorbed carbon dioxide from the DAC media enclosure when the entry and exit doors are closed to thereby seal the enclosure body.

7. The DAC media enclosure of claim 1 further including a gasket disposed on at least one of the entry door or exit door, the gasket facilitating an airtight seal for the entry door or exit door when in the closed position.

8. A direct air capture (DAC) system for removing carbon dioxide from ambient air, the DAC system configured for installation with a dry cooler having a fan for fan-driven air draft over a heat exchanger in the dry cooler, comprising:
one or more enclosures containing temperature-sensitive DAC media, wherein the enclosures are selectively opened to the ambient air or closed to the ambient air;
a support structure providing a plurality of spaces for receiving the enclosures, wherein upon DAC system installation, the support structure exposes the enclosures and enclosed DAC media to an air draft generated by the fan;
a coupling to the dry cooler to tap into a closed loop of working fluid in the dry cooler, the closed loop of working fluid providing cooling by the heat exchanger of heat-producing equipment; and
a fluid distribution system disposed in the support structure for distributing working fluid from the dry cooler to the plurality of receiving spaces in the support structure to provide a source of heat to the DAC media in the enclosures received in the support structure.

9. The DAC system of claim 8 in which the DAC system and dry cooler are positioned relative to each other to implement an induced-draft arrangement for the DAC system.

10. The DAC system of claim 8 in which the DAC system and dry cooler are positioned relative to each other to implement a forced-draft arrangement for the DAC system.

11. The DAC system of claim 10 in which heat applied to the DAC media raises a temperature of the DAC media to a level sufficient to cause desorption of carbon dioxide captured from ambient air in the DAC media.

12. The DAC system of claim 10 further comprising a plurality of microchannels in the support structure providing the receiving spaces, the microchannels providing working fluid channels for the fluid distribution system.

13. The DAC system of claim 8 in which the enclosures and support structure are adapted to enable the enclosures to be removably inserted in the support structure.

14. The DAC system of claim 8 in which the enclosures are selectively opened or closed using one of movable door, cover, flap, or panel.

15. The DAC system of claim 8 in which the heat-producing equipment comprises computer equipment located in a data center, the data center having a liquid-cooling system for the computer equipment, and wherein the closed loop of working fluid is adapted to exchange heat with the liquid-cooling system.

16. A method of operating a direct air capture (DAC) system configured to capture carbon dioxide from air in an environment surrounding the DAC system, the method comprising:
deploying the DAC system adjacent to a dry cooler, the dry cooler having a working fluid loop coupled to a liquid-cooling system in a data center to thereby provide cooling to heat-producing equipment in the data center, wherein the working fluid loop passes the working fluid through at least one heat exchanger in the dry cooler;
tapping the working fluid loop in the dry cooler as a controllable heat source to temperature-sensitive DAC media contained in enclosures in the DAC system, wherein the DAC media captures carbon dioxide and releases captured carbon dioxide as a function of DAC media temperature, and wherein the enclosures are controllably openable to airflow and controllably sealable against airflow;
operating a fan system in the dry cooler to both flow air over the DAC media in the enclosures opened to the airflow to capture carbon dioxide from the air and flow the air over the dry cooler heat exchanger; and
sealing the enclosures against airflow and controllably applying heat to the DAC media therein from the tapped working fluid loop in the dry cooler to release the captured carbon dioxide into the sealed enclosures.

17. The method of claim 16 further including evacuating the carbon dioxide from the sealed enclosures using a pump in the DAC system.

18. The method of claim 17 further including using a compressor in the DAC system to compress the evacuated carbon dioxide for storage.

19. The method of claim 16 further including evacuating water vapor from the sealed enclosures, condensing water from the evacuated vapor, and providing the condensed water to a water supply for a water sprayer system utilized by the dry cooler in an adiabatic cooling process.

20. The method of claim 16 in which the method is automated using a computer-implemented process monitoring and control application that implements predictive control techniques based on machine learning.
